(19) United States
(12) Patent Application Publication
(10) Pub. No.: US 2026/0241909 A1
(43) Pub. Date: Aug. 20, 2026

(54) HYDRAULIC ACTUATOR

(71) Applicant: Robert Bosch GmbH, Stuttgart (DE)

(72) Inventors: Martin Hagspiel, Rettenberg (DE); Andreas Weh, Sulzberg (DE)

(21) Appl. No.: 19/353,808

(22) Filed: Oct. 9, 2025

(30) Foreign Application Priority Data
Feb. 14, 2025 (DE) 10 2025 105 509.2

(51) Int. Cl. B60T 13/74; H02K 11/21

(52) U.S. Cl. CPC B60T 13/745; H02K 11/21

(57) ABSTRACT

A hydraulic actuator for a brake system. The hydraulic actuator includes a controllable drive machine, in particular an electric motor, a hydraulic unit, which is coupled to the drive machine and is configured to generate a hydraulic pressure for the brake system when the drive machine is controlled, and a control unit, which is in particular configured to control the drive machine depending on a braking request. The control unit is disposed between the drive machine and the hydraulic unit.

### CROSS REFERENCE

The present application claims the benefit under 35 U.S.C. § 119 of Germany Patent Application No. DE 10 2025 105 509.2 filed on February 14, 2025, which is expressly incorporated herein by reference in its entirety.

### FIELD

The present invention relates to a hydraulic actuator for a brake system, comprising a controllable drive machine, in particular an electric motor, a hydraulic unit, which is coupled to the drive machine and is configured to generate a hydraulic pressure for the brake system when the drive machine is controlled, and a control unit, which is in particular configured to control the drive machine depending on a braking request.

### BACKGROUND INFORMATION

Certain hydraulic actuators are described in the related art. The electrification of functions and structural units in brake systems of motor vehicles is increasing as well. For example, it is conventional to configure a brake booster, which is conventionally configured as a vacuum brake booster, as an electromotive or electromechanical brake booster. Also conventional are braking force generators, which generate the hydraulic pressure in the brake system by means of an electric motor without the need for a direct mechanical coupling between the brake pedal and the hydraulic circuit. A typical hydraulic actuator comprises a hydraulic unit and a drive machine that are fixedly connected to one another. In most cases, there is also a control unit, which controls the drive machine depending on a detected braking request in order to generate a desired brake pressure or hydraulic pressure with the aid of the hydraulic unit. The hydraulic unit usually comprises a so-called hydraulic block, i.e., a solid housing, which is configured as a hydraulic aluminum block, for instance, in which hydraulic channels and receptacles for actuator components are configured, for example in the form of bores or other recesses. The drive machine and the control unit are typically fastened to this hydraulic block, for example by means of screws.

### SUMMARY

A hydraulic actuator according to the present invention may have the advantage that the hydraulic actuator is configured in an installation space-saving manner, so that the available installation space in the motor vehicle can be better utilized. The electrical interfaces between the different assemblies, i.e. between the drive machine, the hydraulic unit, and/or the control unit, can in particular be optimized as well. According to an example embodiment of the present invention, it is provided for this purpose that the control unit is disposed between the drive machine and the hydraulic unit. Consequently, for example, the power supply of the drive machine does not have to be guided through the hydraulic unit, but instead preferably takes place directly from the control unit to the drive machine over a short distance. The arrangement furthermore enables the use of insulation displacement connections which enable easy installation of the hydraulic actuator.

According to a preferred further development of the present invention, the control unit comprises a recess through which a rotor shaft of the drive machine is guided to the hydraulic unit. The rotor shaft thus penetrates the control unit, which ensures a particularly compact configuration. For this purpose, the control unit comprises a recess with a closed peripheral edge or a recess with an open edge, for example, which enables easy installation of the control unit in radial direction relative to the rotor shaft.

According to an example embodiment of the present invention, it is particularly preferred that the control unit comprises a printed circuit board which includes said recess. A processor, a memory, a communication module and/or power electronics for the drive machine are disposed on the printed circuit board, for instance, and are electrically connected to one another by means of conductor tracks.

At least one sensor, in particular a rotational position sensor, is preferably disposed on the printed circuit board and is associated with the recess. The sensor is therefore disposed on the printed circuit board close to the recess, and is thus positioned close to the rotor shaft of the drive machine which passes through the recesses. The configuration as a rotational position sensor has the advantage that it is advantageously possible to acquire the rotational angle position or the rotational position of the rotor shaft. The sensor also monitors the rotational speed of the rotor shaft, for example, and thus the rotational speed of the drive machine.

According to a preferred further development of the present invention, at least one signal generator for the rotational position sensor is disposed on the rotor shaft. This is used to ascertain the optimum rotational position.

According to an example embodiment of the present invention, preferably, at least one housing part of the control unit is formed by a housing of the drive machine. The housing of the drive machine thus forms the housing part of the control unit, which enables a particularly compact configuration of the hydraulic actuator. The housing part of the control unit is in particular formed by a pole pot of the drive machine.

According to a preferred further development of the present invention, at least one housing part of the control unit is formed by a bearing wall of the hydraulic unit, in which case in particular a ring gear of the hydraulic unit is held on the bearing wall. This results in further integration of the control unit into the already existing housing parts of the hydraulic unit. The one housing part of the control unit is preferably formed by the drive machine and another housing part of the control unit is formed by the bearing wall of the hydraulic unit, so that the control unit is, for instance, enclosed by the bearing wall of the hydraulic unit and the pole pot of the drive machine. This, too, simplifies the installation of the hydraulic actuator. It is particularly preferred that the ring gear is connected to the bearing wall or the housing part of the control unit in a rotationally fixed manner, so that it is advantageously supported by the control unit.

According to an example embodiment of the present invention, a pedal feel simulator is particularly preferably disposed on the side of the hydraulic unit facing away from the drive machine. Because the control unit is disposed between the drive machine and the hydraulic unit, the side of the hydraulic unit facing away from the drive machine is at least largely free, so that the pedal feel simulator now is or can be fastened directly to the hydraulic unit, in particular to the hydraulic block, which thus provides a highly functional hydraulic actuator for a brake system of a motor vehicle.

According to another example embodiment of the present invention, a reservoir for accommodating and providing hydraulic medium, in particular brake fluid, is disposed on the side of the hydraulic unit facing away from the drive machine. The reservoir is preferably provided in addition to or as an alternative to the pedal feel simulator. The arrangement of the reservoir on the side facing away from the drive machine results in a further advantageous adaptation of the hydraulic actuator to the installation space conditions in a motor vehicle. The reservoir is in particular configured such that it at least largely covers the side of the hydraulic unit facing away from the drive machine and thus advantageously protects the side of the hydraulic unit facing away from the drive machine, and with it any structural units such as valves, pedal feel simulator and/or sensors disposed on this side, from external influences. The reservoir preferably also provides corrosion protection for uncoated components of the hydraulic actuators, such as a pedal feel simulator fastened to the hydraulic block. For this purpose, the reservoir preferably extends at least over a region of the end face of the hydraulic block in which the pedal feel simulator is disposed.

According to an example embodiment of the present invention, the control unit preferably also comprises a fill level sensor which is assigned to the reservoir through at least one through-opening of the hydraulic unit. There is therefore a through-opening, for example in the form of a bore in the hydraulic block, that extends through the hydraulic unit, through which the fill level sensor interacts with the reservoir. The fill level sensor is disposed on the control unit, in particular on the printed circuit board, or directly on the reservoir, and is connected to the control unit via a signal connection that passes through the through-opening of the hydraulic unit.

The present invention will be explained in more detail in the following with reference to the figures.

### BRIEF DESCRIPTION OF THE DRAWINGS

FIG. 1 shows a first embodiment example of an advantageous hydraulic actuator in a simplified longitudinal sectional view, according to the present invention.

FIG. 2 shows a second embodiment example of the hydraulic actuator in a simplified longitudinal sectional view, according to the present invention.

### DETAILED DESCRIPTION OF EXAMPLE EMBODIMENTS

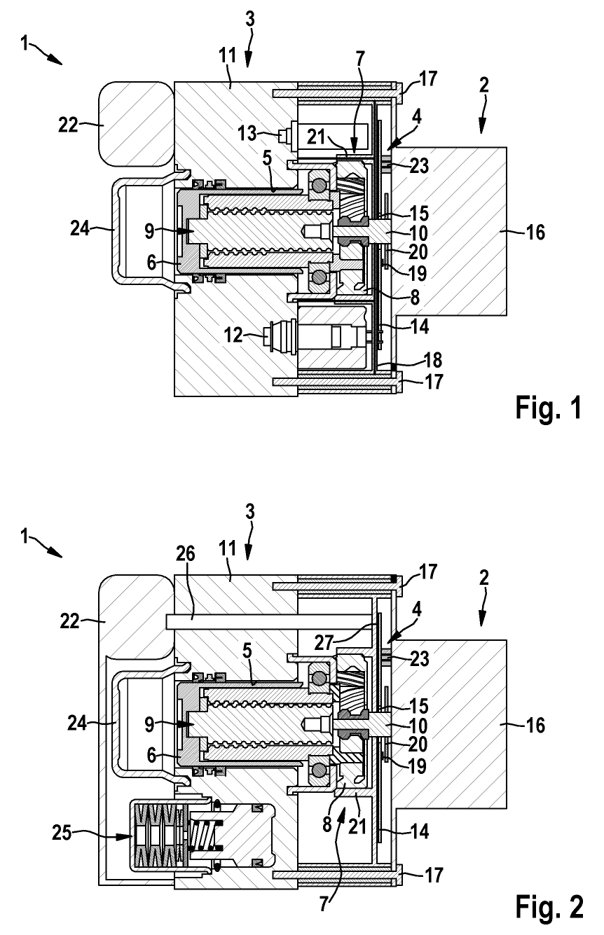

FIG. 1 shows a simplified longitudinal sectional view of an advantageous hydraulic actuator 1 comprising an electric drive machine 2, a hydraulic unit 3 which can be operated via the drive machine 2, and a control unit 4. The control unit 4 is configured to control the drive machine 2 depending on a request, in particular a braking request, in order to generate a hydraulic pressure, for example in a brake circuit of a brake system not shown here, with the aid of the hydraulic unit 3. The hydraulic actuator is in particular a brake actuator of the brake system. For this purpose, the hydraulic unit 3 according to the present embodiment example comprises a hydraulic piston 6 that can be displaced in a hydraulic cylinder 5.

The electric drive machine 2 is coupled here to the hydraulic piston 5 by means of a gearing 7, which is in particular configured as a planetary gear transmission with a sun gear, planet gears and a ring gear 8, and a spindle gear 9, by means of which the rotational movement of a rotor shaft 10 of the drive machine 2, which is advantageously transmitted by the planetary gear transmission, is converted into a translational movement of the hydraulic piston 6.

The hydraulic unit 3 comprises a hydraulic block 11, in which the hydraulic cylinder 5 is formed and in which a solenoid valve 12 and a pressure sensor 13. for example, are disposed. The pressure sensor 13 and the solenoid valve 12 are, in particular electrically, connected to the printed circuit board 14 or to conductor tracks of the printed circuit board 14.

The control unit 4 is advantageously disposed between the drive machine 2 and the hydraulic block 11 or the hydraulic unit 3. The control unit 4 comprises a printed circuit board 14 that, in particular in the center, comprises a recess 15 through which the rotor shaft 10 is guided. The recess 15 in the printed circuit board 14 here is circular and is configured such that it is closed around its periphery so that the rotor shaft 10 can be passed axially through the recesses 15 during installation.

The drive machine 2 comprises a housing 16, in particular a pole pot, which completely covers and thus encloses the printed circuit board 14. The housing 16 therefore forms a housing part of the control unit 4. The housing 16 is in particular fastened to the hydraulic block 3 by means of one or more fastening screws 17 or fastening pins. The hydraulic block 11 in particular comprises a front-side receiving recess 18 in which the printed circuit board 14, the gearing 7, the sensor 13 and the solenoid valve 12 are disposed. The hydraulic block 3 thus forms a further housing part of the control unit 4. The control unit 4 is therefore advantageously enclosed as a whole by the hydraulic block 3 and the drive machine 2 or their housing 16.

A rotational position sensor 19 is also disposed on the printed circuit board 14 opposite to a signal generator 20, which is connected to the rotor shaft 10 in a rotationally fixed manner, in order to monitor a rotational position or an angle of rotation of the rotor shaft 10.

A bearing wall 21, to which the ring gear 8 of the planetary gear transmission is fastened, is optionally mounted on the hydraulic block 3. The bearing wall 21 preferably forms a housing part of the control unit 4 and protects it, for example from the hydraulic medium.

A reservoir 20, which serves to accommodate and provide a hydraulic medium, in particular brake fluid, is optionally also disposed on the hydraulic unit 3 on the side facing away from the drive machine 2. The reservoir 22 is in particular connected to the hydraulic cylinder via one or more here not depicted channels.

The advantageous arrangement of the printed circuit board 14 or the control unit 4 between the drive machine 2 and the hydraulic unit 3 ensures a simple electrical contact-connection between the drive machine 2 and the control unit 4, for example by means of insulation displacement connections 23. The central arrangement of the control unit 4 also advantageously ensures the connection to the sensor 13 and/or the valve 12. Overall, the advantageous arrangement of the control unit 4 ensures a compact embodiment of the hydraulic actuator 1.

FIG. 2 shows a simplified longitudinal sectional view of another embodiment example of the hydraulic actuator 1, in which elements already shown in FIG. 1 are provided with the same reference signs and reference is made in this respect to the above description. The following focuses primarily only on the differences.

In contrast to the previous embodiment example of the present invention, the reservoir 22 here is configured such that it extends over the entire end face of the hydraulic block 11 and thus also covers an end cap of the hydraulic cylinder 5.

A pedal feel simulator 25, which is hydraulically and/or mechanically coupled to a brake pedal of the brake system, is optionally disposed directly on, and in particular at least partially within, the hydraulic block 11. The pedal feel simulator 25 is likewise disposed on the side of the hydraulic block 11 or the hydraulic unit 3 facing away from the drive machine 2.

The hydraulic block 11 advantageously also comprises a through-opening 26 that leads from the reservoir 22 to the printed circuit board 14, in which case a fill level sensor 27, for instance, for example an ultrasonic sensor, is disposed on the printed circuit board 14 facing the through-opening 26 in order to monitor the fill level of the reservoir 22. Alternatively, the fill level sensor 27 is disposed directly on the reservoir 20 and is electrically connected to the printed circuit board 14 via the through-opening 26.

What is claimed is:

1. A hydraulic actuator for a brake system, comprising:
a controllable drive machine including an electric motor;
a hydraulic unit, which is coupled to the drive machine and is configured to generate a hydraulic pressure for the brake system when the drive machine is controlled; and
a control unit configured to control the drive machine depending on a braking request, wherein the control unit is disposed between the drive machine and the hydraulic unit.

2. The hydraulic actuator according to claim 1, wherein the control unit includes a recess through which a rotor shaft of the drive machine is guided to the hydraulic unit.

3. The hydraulic actuator according to claim 2, wherein the control unit includes a printed circuit board which includes the recess.

4. The hydraulic actuator according to claim 3, wherein at least one sensor, including a rotational position sensor, is disposed on the printed circuit board and is associated with the recess.

5. The hydraulic actuator according to claim 4, wherein at least one signal generator for the rotational position sensor is disposed on the rotor shaft.

6. The hydraulic actuator according to claim 1, wherein at least one housing part of the control unit is formed by a housing of the drive machine.

7. The hydraulic actuator according to claim 1, wherein at least one housing part of the control unit is formed by a bearing wall of the hydraulic unit, wherein a ring gear of the hydraulic unit is held on the bearing wall.

8. The hydraulic actuator according to claim 1, wherein a pedal feel simulator is disposed on a side of the hydraulic unit facing away from the drive machine.

9. The hydraulic actuator according to claim 1, wherein a reservoir for accommodating and providing hydraulic medium including brake fluid, is disposed on a side of the hydraulic unit facing away from the drive machine.

10. The hydraulic actuator according to claim 9, wherein the control unit includes a fill level sensor which is assigned to the reservoir through at least one through-opening of the hydraulic unit.
